(19) United States
(12) Patent Application Publication
(10) Pub. No.: US 2004/0039602 A1
(43) Pub. Date: Feb. 26, 2004

(54) Clinician's assistant system

(76) Inventors: Robert S. Greenberg, Glenelg, MD (US); William A Sellers, Edgewaters, MD (US); Peter Staats, Baltimore, MD (US); Myron Yaster, Baltimore, MD (US)

Correspondence Address: Francis A Cooch, The John Hopkins University, Applied Physics Laboratory, 11100 Johns Hopkins Road, Laurel, MD, 20723-6099, US

(21) Appl. No.: 10/415,679

(22) PCT Filed: Nov. 16, 2001
(86) PCT No.: PCT/US01/43834

(51) Int. Cl. G06F 17/60

(52) U.S. Cl. 705/2

(57) ABSTRACT

A clinician's assistant system including examination and treatment modules to guide a clinician in examining and treating a patient. The system is configured to communicate with databases storing patient data and treatment data. The modules display information to and solicit information from a clinician via a display device, e.g. using menus and graphical user interfaces, to ensure that the patient is properly evaluated and treated. Optionally, the system is capable of recommending a treatment, e.g. as a function of patient information known to the system. The system can help create documents by presenting the clinician with selectable phrases, and/or by incorporating data into predefined document templates. The system provides multi-patient research, voice recognition, and billing capabilities. The system may be implemented, at least in part, in a pen-based portable computer so that patient medical record and/or treatment data is available, and examination data is recorded, at the point of care.

### CROSS-REFERENCE TO RELATED APPLICATIONS

This application claims the benefit of prior filed co-pending U.S. Application No. 60/249,622, filed November 17, 2000, the disclosure of which is hereby incorporated herein by reference.

### BACKGROUND OF THE INVENTION

1. Field of the Invention

The present invention relates to electronic health care systems, and more particularly, to a system for creating and storing medical records, assisting in evaluating and treating patients, in analyzing multiple patients medical records for research purposes, for optimizing clinical care by interfacing with clinical algorithms, and in creating electronic and printed medical record documents, including orders and bills that are in compliance with third party regulations.

2. Description of the Related Art

Health care providers, such as physicians, physician's assistants, nurses, etc. (collectively, “clinicians”), create large volumes of patient data and information for inclusion in medical records during the course of their business at health care facilities, such as hospitals, clinics, laboratories and medical offices. For example, when a physician treats a patient, the physician generally creates or adds to a patient file, including the patient's medical history, past, current and prescribed therapies, past, current and prescribed medications, and other pertinent information. By way of further example, hospital clinicians making rounds to inpatients regularly examine and assess patients, monitor changes in the patient's health, and modify treatment plans, including administration of medications, etc. These activities may involve generation of referral clinician in treating the patient and recording treatment data for storage in the patient database. The modules display information to and solicit information from a clinician via a display device, e.g. using graphical user interfaces. In a preferred embodiment, the present invention is implemented, at least in part, in a pen-based portable computer that the clinician carries when making rounds, examining patients, etc. In this manner, the system helps to ensure that the patient is properly evaluated, all pertinent information is gathered, etc. and that all appropriate treatment options are considered. Additionally, patient medical record data is available, and examination data is recorded, at the point of care. Optionally, the system may store a protocol database accessible by the examination and/or treatment modules to guide the clinician through examination and treatment according to predefined protocols. For example, these treatment protocols can be established on the basis of clinical pathways, research protocols, or cost of care.

In some embodiments, the treatment module is also capable of recommending a treatment, e.g. as a function of patient information known to the system as a result of examination data or stored medical records data. For example, this may include recommending therapies, drugs, dosages, and/or delivery methods. Accordingly, the burden on the clinician of manually referencing materials or performing mental calculations is lessened or eliminated.

The system provides a documentation module which, in cooperation with the examination and/or treatment module, can assist a clinician in creating medical records relating to examination and treatment of a patient. For example, the clinician may be presented with a list of phrases, e.g. arranged in a pick list or a logic tree, which are clinician-selectable as appropriate to properly document patient examination, treatment, etc. This lessens the burden on the clinician to hand write notes, orders, etc. and quickly helps to ensure their completeness and legibility. Accordingly, relatively lengthy textual notes may be created by the system from relatively short phrases quickly selected by a clinician. The system is capable of generating medical and related records (collectively, “medical records”), such as examination notes, orders, bills, referral letters, etc., by incorporating relevant data stored by the system into predefined templates, such as Microsoft Word or Excel documents. This helps to ensure completeness and legibility of the notes, orders, etc. and can provide printable copies for archival or backup purposes, or for use to enter data into legacy systems. A document preview module may allow the clinician to view medical records created by the system prior to printing, e.g. via a display screen.

The system may include a research module providing research capabilities by allowing multiple patients records to be sorted, grouped, or analyzed, e.g. as a function of a selected condition, treatment, etc. This reduces or eliminates burdens on publishing clinicians in conducting research studies by having the system perform at least a preliminary analysis of multiple patients medical records. This module can also have an internal randomization protocol to facilitate randomized control trials.

The system may also include a voice recognition module providing voice recognition capabilities such as speech-to-text, text-to-speech, and voice command capabilities. This allows the clinician to dictate to the system and have his/her dictation translated into text, to have text read from the system to the clinician, and to control the system by voice, all of which are particularly useful when the clinician's hands are otherwise occupied, as is often the case during examination and treatment.

The system may further include a billing module providing billing capabilities by providing a billing database and a billing module. The billing module is configured to communicate with the billing database and to display a corresponding menu of clinician-selectable billing level options corresponding to data stored in the billing database. The billing module queries the system, e.g. created text, to ensure that the appropriate documentation is provided to support a selected billing level option according to third party regulations.

### BRIEF DESCRIPTION OF THE DRAWINGS

FIG. 1 is a block diagram of an exemplary embodiment of a clinician's assistant system in accordance with the present invention.

FIG. 2 is a block diagram of an exemplary embodiment of a pen-based computer for implementing the clinician's assistant system of FIG. 1.

FIG. 3 is a flow diagram of an exemplary embodiment of a method for using the clinician's assistant system of FIG. 1.

FIGS. 4, 5 and 7 show exemplary graphical user interface windows displayable by the examination module for guiding a clinician in examining a patient.

FIGS. 6 and 8-12 show exemplary graphical user interface windows displayable by the treatment module for guiding a clinician in treating a patient.

FIG. 13 shows an exemplary document template for use by the documentation module in creating a medical records document.

FIG. 14 shows an exemplary medical records document created by the documentation module using the document template of FIG. 13.

FIG. 15 shows an exemplary graphical user interface window displayable by the document preview module to display a textual document created by the documentation module.

### DETAILED DESCRIPTION

The present invention provides a clinician's assistant system for assisting a clinician in examining and treating a patient. To do so, the system may reference databases of patient medical record data, examination options, treatment options (including medication, dosage and delivery options) and protocols (including assessment and treatment protocols). By changing data in the databases, the system may be customized for particular purposes, e.g. for pain management, for treatment of heart patients, etc., or preconfigured to guide the clinician in a predetermined way, as governed by the databases and/or the modules referencing the databases. The system assists in the creation of medical record documents. For illustrative purposes, the present invention is discussed below with reference to an exemplary system customized for patient pain management.

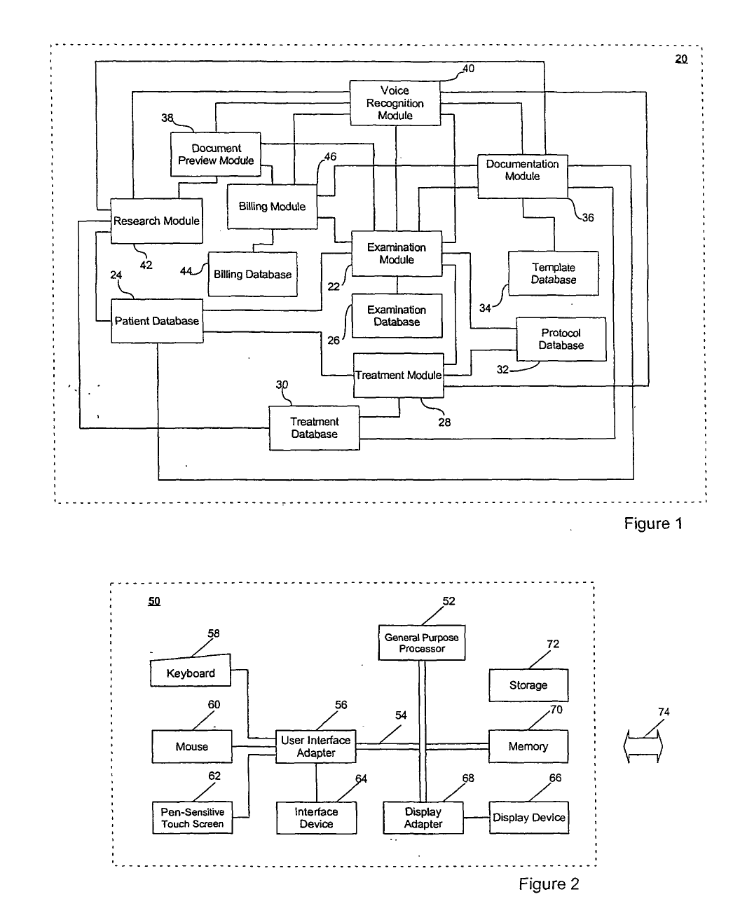

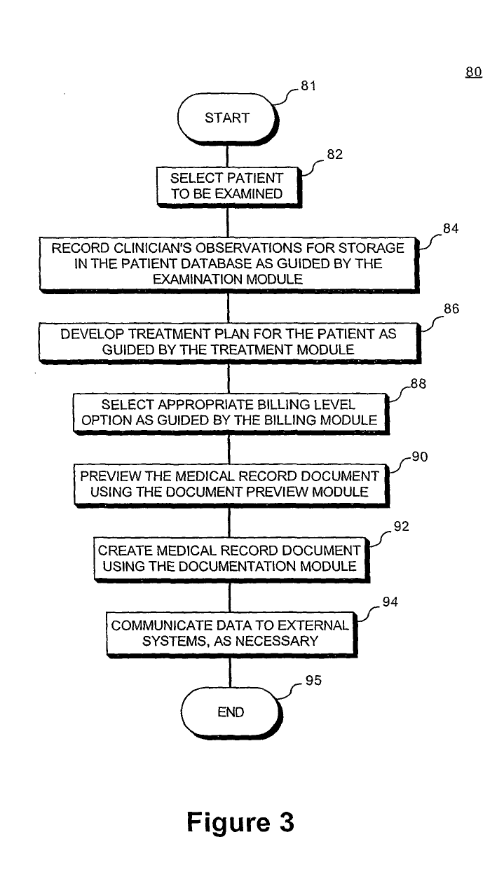

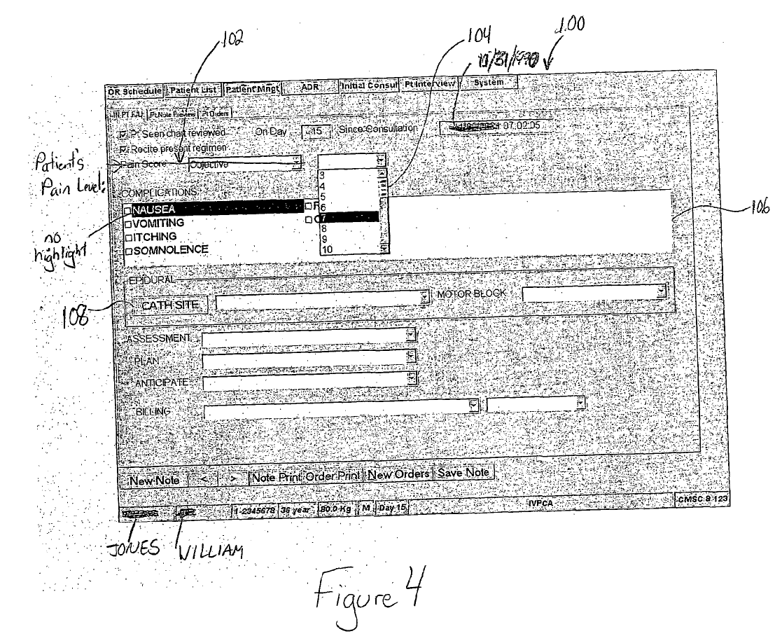

An overview of the system and method of FIGS. 1-3 is provided below. FIG. 1 is a block diagram of an exemplary embodiment of a clinician's assistant system 20 in accordance with the present invention, as discussed in detail below. It should be noted that the block diagram of FIG. 1 shows functional-related separation of components for illustrative purposes and is not intended to imply actual separation of components. The exemplary embodiment shown in FIG. 1 is implemented, at least in part, in a pen-based computer 50, shown in FIG. 2, as discussed in detail further below. For example, the present invention may be implemented using a Fujitsu Point 1600 pen-based tablet computer manufactured and/or distributed by Fujitsu PC Corporation of Santa Clara, Calif., U.S.A. The present invention may be software-implemented in any suitable manner, including networked and stand-alone workstation environments, on general-purpose or special-purpose notebook, desktop, and/or handheld computers, as will be appreciated by those skilled in the art. A system according to the present invention may include a number of modules as discussed further below. Each of the modules may be software-implemented according to programming methods and techniques well known in the art. FIG. 3 is a flow diagram 80 of an exemplary embodiment of a method for using the clinician's assistant system of FIG. 1. The flow diagram provides an overview of an exemplary method of using certain aspects of the present invention, as discussed below.

The exemplary method of FIG. 3 is discussed in detail below with reference to the system of FIGS. 1 and 2. As shown in FIG. 3, the method starts with the selection of a patient to be examined, as shown at steps 81 and 82. For example, this may include downloading or retrieving information from an external system, such as a hospital legacy system, or a patient database 24 internal to the system. By way of further example, this step may involve retrieval of an operating room scheduling list indicating which patients have had surgery and are in need of post-operative pain management. For example, the patient may be selected from a menu by touching a stylus/pen to the patient's name as displayed on a pen-sensitive touch screen of the system. This results in retrieval of the patient's medical records data, which may include the patient's medical history, age, height, weight, etc. Programming methods, hardware and software for implementing touch screen based computer systems are well known in the art. Optionally, the systems functions for implementing this step 82 are carried out by the examination module 22, as discussed further below.

As shown in FIG. 3, the clinician's examination observations are then input to the system, as shown at step 84. For example, the clinician's examination observations may be input using the stylus/pen and touch screen 62 of FIG. 2. This step may be implemented by the examination module 22 shown in FIG. 1.

The examination module 22 is capable of guiding a clinician in examining a patient and recording examination data for storage in a patient database 24 storing medical record data relating to a patient. In the exemplary system of FIGS. 1-13, the system displays one or more graphical user interface (GUI) windows soliciting input from the clinician and/or providing information to the clinician to guide the clinician through the examination process. Exemplary GUI windows are shown in FIGS. 4, 5 and 7 for a system specialized for patient pain management. When the clinician provides examination observation data to the system, e.g. by selecting an examination option displayed in the GUI window, such data is recorded for storage in the patient database 24. The recording may occur, for example, instantaneously or periodically, and selectively or automatically. For example, the GUI may provide a text entry box adjacent the text “PATIENT'S PAIN LEVEL:” to guide the physician to enter examination free form data, such as the patient's subjective assessment of the patient's pain level, by keyboard, writing with a stylus/pen, selecting with a mouse, etc.

In a preferred embodiment, all or nearly all input to be provided by the clinician can be input by selecting a displayed option from a pick list, menu, etc. In such an embodiment, the system 20 may include an examination database 26 accessible to the examination module 22 and storing data relating to examination observation options. For example, the examination database may store examination observation options for pain levels of 1, 2, 3, 4, 5, 6, 7, 8, 9, and 10. In such an embodiment, the examination module 22 is configured to communicate with the examination database 26 and to display a corresponding menu of clinician-selectable examination observation options. Accordingly, adjacent the text “PATIENT'S PAIN LEVEL:” 102 in the examination module window 100 shown in FIG. 4, the examination observation options 1-10 are displayed as clinician-selectable options in a scrollable drop-down window 104. Accordingly, the system 20 guides the clinician to rate and record the patient's pain level on a scale of 1-10. In the example of FIG. 4, the clinician has selected a pain level of 7, e.g. after consulting with the patient. Corresponding examination observation data is stored in the patient database 24 and becomes part of the patient's medical record data that may be recalled by the system and reviewed by a clinician at a later time, as described above. Accordingly, medical records may be created in “real time”, at the point of care, without the need for subsequent transcription and/or deciphering of a clinician's handwriting.

As shown in the example of FIG. 4, the examination module window 100 also displays a list of clinician-selectable possible complications for the patient in a subwindow 106. Accordingly, the system 20 guides the clinician to consult with the patient or otherwise determine whether the patient is experiencing any complications, e.g. from a surgery, from current treatments, etc. In this manner, the system guides the clinician to help ensure that the examination is complete. The clinician may select all complications that apply and the examination module 22 records the examination observation data in the patient database 24 as part of the patient's medical records data. Additionally, by presenting physician-selectable options, the clinician may quickly make notes. For example, the clinician may select the VOMITING complications option with a single touch of a stylus/pen, a single mouse-click, etc., which is quicker and easier than making handwritten notes.

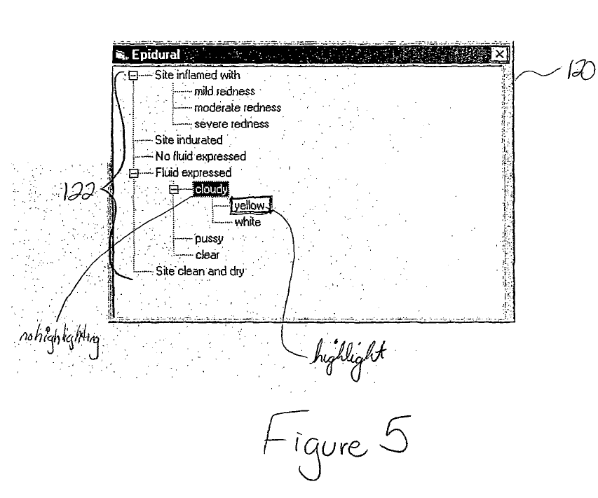

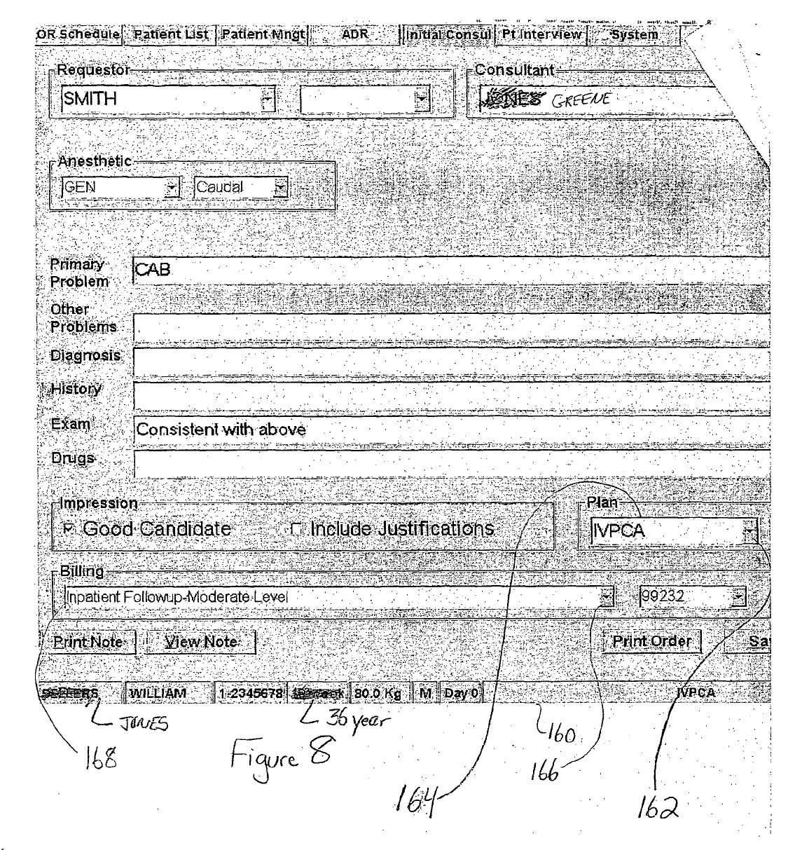

Optionally, the examination module 22 is configured to display the menu of examination options as a tree of phrases 122, as shown in window 120 of FIG. 5. The tree of phrases 122 is constructed according to the examination observation option data stored in the examination database 26. The tree of phrases 122 may be arranged in a logical, hierarchical structure that allows for relatively quick selection by a clinician to indicate which examination observation options apply to the subject patient. In the example of FIG. 5, examination observation options are shown for describing the patient's catheterization site. For example, this tree of phrases 122 may be displayed responsive to selection of a corresponding button 108 in window 100, as shown in FIGS. 4 and 7. As shown in FIG. 5, the clinician may simply select “yellow” with a single touch of a stylus/pen or click of a mouse. From this, the system may build the descriptive, textual examination observation “Fluid expressed cloudy yellow”, as described below. Alternatively, the clinician may build the same descriptive phrase by first selecting “fluid expressed”, then “cloudy”, then “yellow”. In this manner, the tree structure guides the clinician in preparing a complete note. Accordingly, the system 20 allows the clinician to avoid the pitfalls of free-form note taking and to record examination observations more quickly, more completely, and likely more legibly, than using handwriting, typing, etc. Corresponding examination observation data is then recorded in the patient database 24, and may be displayed in an appropriate text box 110 of window 100, as shown in FIG. 7.

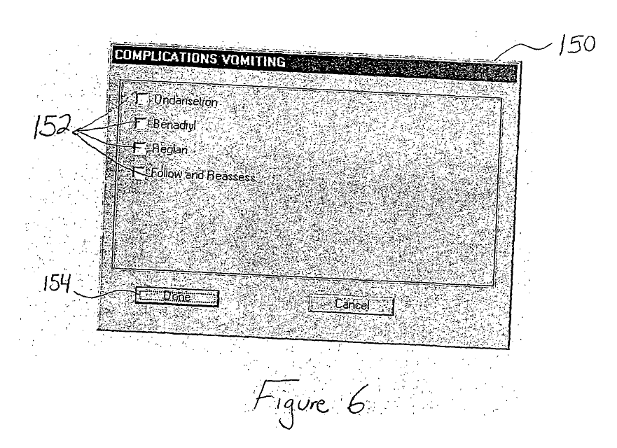

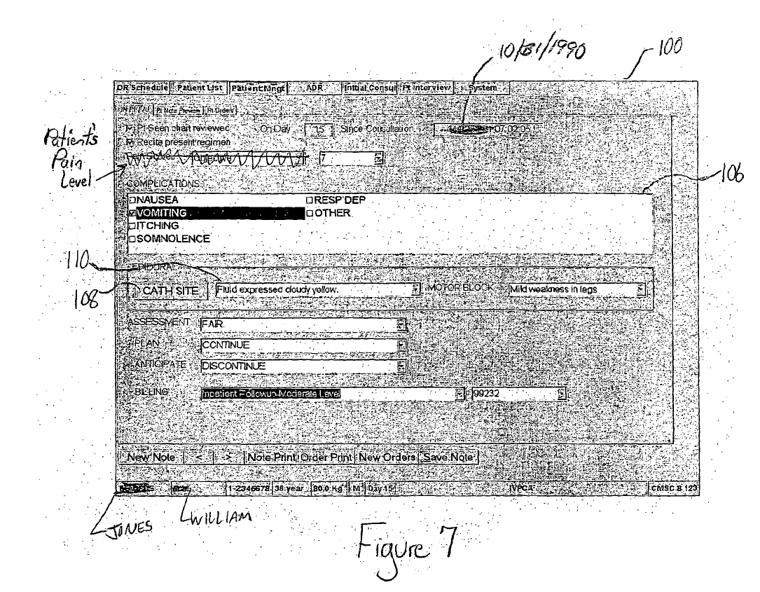

Referring now to FIG. 3, the method next includes a step of developing a treatment plan for the patient, as shown at step 86. This step may be implemented by the treatment module 28 of FIG. 1. The treatment module 28 is capable of guiding the clinician in treating the patient and recording treatment data for storage in the patient database 24. In the exemplary system of FIGS. 1-13, the system displays one or more graphical user interface (GUI) windows soliciting input from the clinician and/or providing information to the clinician to guide the clinician in developing, conducting, and/or monitoring a treatment plan. Exemplary GUI windows displayed by the treatment module 28 are shown in FIGS. 6 and 9-11 for the exemplary patient pain management system discussed above. When the clinician provides treatment data to the system, e.g. by selecting an appropriate option displayed in the GUI window, such data is recorded for storage in the patient database 24. For example (not shown), the GUI window may provide a text entry box adjacent the text “PRESCRIPTION:” to guide the physician to enter treatment free form data, such as the clinician's prescription of a medication, by keyboard, writing with a stylus/pen, etc.

Alternatively, the system 20 includes a treatment database 30 storing data relating to treatments available to patients, such as therapies, prescriptions, medications, dosages, delivery methods, or other doctor's orders, such as conditional treatment orders, requests for follow-up by nurses at prescribed intervals, etc. For example, the treatment database 30 may store treatment options of Ondansetron, diphenhydramine (Benadryl), metaclopramide (Reglan), and Follow and Reassess for treatment of a Vomiting condition. In such an embodiment, the treatment module 28 is configured to communicate with the treatment database 30 and to display a corresponding menu of clinician-selectable examination options when VOMITING is indicated by the clinician as the patient's condition. For the example of FIG. 4, if the clinician selects examination observation option VOMITING in subwindow 106, this causes treatment option window 150 (FIG. 6) to be displayed. In the example of FIG. 6, the treatment options for VOMITING from the treatment database 30 are displayed in treatment option window 150 as a menu of clinician-selectable treatment options (selectable with a stylus/pen, mouse, etc. to check the corresponding checkbox 152). Accordingly, the system 20 guides the clinician to consider treatment options of Ondansetron, Benadryl, Reglan, and Follow and Reassess to treat the patient's vomiting. After selecting a treatment option, the clinician can confirm the option and cause it to be stored in the patient database 24 to become part of the patient's medical record data by selecting “DONE” button 154. In this manner, the system helps to ensure that a complete, or a preferred, range of treatment options is considered, and allows the clinician to quickly make notes, write orders, etc. Because the treatment options are selected from a list, legibility of the clinician's handwriting is not an issue. Additionally, the medical record may be created in “real time”, at the point of care, without the need for subsequent transcription of notes, data entry, etc.

In some embodiments, the treatment module 28 is configured to communicate with the patient database 24 and the treatment database 30 and to recommend a treatment option appropriate for the patient as a function of the patient's available to patients stored in the treatment database 30. In other words, rather than display all possible treatment options, the system displays only those treatment options appropriate to the patient. For example, if the patient database 24 stores data indicating an allergy to a certain medication, that medication is excluded as a clinician-selectable treatment option and is not displayed to the clinician as an available treatment option for the patient.

In addition to selecting a treatment option appropriate for the patient as a function, inpart, of the treatments available to patients, the present invention can dynamically process treatment options, i.e., over time recognize the “best” treatment based on the historical population data of the system. The “best” treatment in its simplest form, e.g., 87% of vomiting is effectively treated with a specified drug, is then selected and presented first to the clinician.

In some embodiments, the treatment database 30 includes a medication database (not shown) storing dosage data. For example, the medication database may store data indicating medications, for which conditions they are or are not to be used, contraindications, programmable IV pump settings such as demand lockout time, maximum doses per hour, clinician bolus values, dosage rates as related to age, weight, etc. In such an embodiment, the treatment module 28 is configured to communicate with the patient database 24 and the medication database and to recommend a medication dosage option appropriate for the patient as a function of the patient's medical record data stored in the patient database and dosage data stored in the medication database. For example, the medication database may contain dosage data indicating that, for a given medication, a dosage of 0.5 mcg/kg/hr is recommended. For example, this may be determined as a function of a patient's age, weight, pain level, or other factors.

By way of further example, the system 20 may include a protocol database 32 storing a treatment protocol that indicates a dosage of 0.5 mcg/kg/hr as an appropriate initial dosage. In such an embodiment, the treatment module 28 is configured for automating the treatment protocol, e.g. by making treatment recommendations according to the protocol. For example, the protocol may determine which treatments are available, which drugs and therapies are prescribed or are available treatment options, the order of preference of use of such drugs and therapies, drug dosages, preferred delivery options, preferred order of delivery options, preferred method of delivery (oral, IV or IM), make recommendations as to which combination of drugs are most effective or potentially harmful, etc., make recommendations as to actions to be taken or tests to be administered by medical personnel, etc. For example, the protocols can be established on the basis of clinical pathways, research protocols or cost of care. Accordingly, the protocol database 32 can, for example, assist the treatment module 28 and/or the clinician to prompt clinicians to offer the most cost effective approach where medically necessary, to specify treatment with selected medications, or brands of medications, etc.

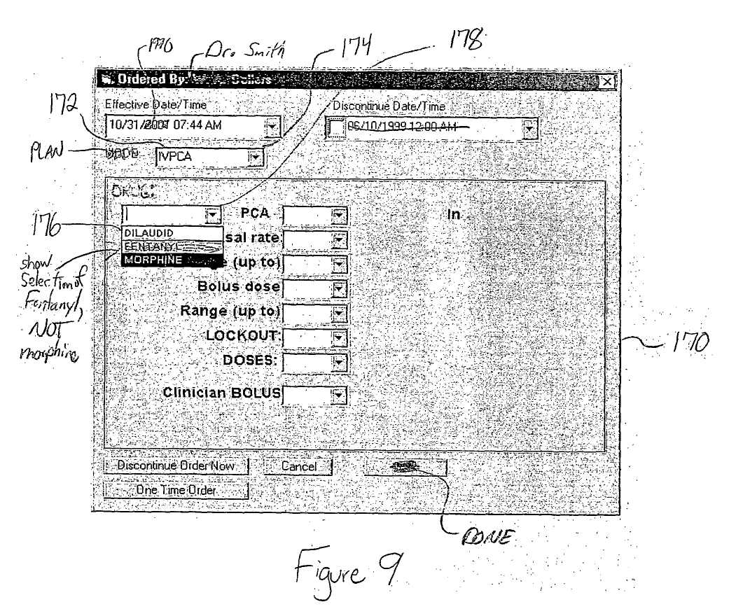

FIGS. 8-10 show exemplary GUI windows displayed by the treatment module 28. By way of example, consider that the patient in the example is recovering from surgery and in need of medication to control post-operative pain. FIG. 8 shows an exemplary window 160 displayed by treatment module 28. This window 160 allows a clinician to select an appropriate treatment plan for controlling the patient's postoperative pain. In the example, the window 160 provides a list of treatments available to patients for pain control in a drop-down menu that is accessible by selecting button 162. For example, the menu may contain delivery treatment options including Intravenous Patient Controlled Analgesia (IVPCA), Epidural Continuous (EPIDCON), Epidural Patient Controlled Analgesia (EPIDPCA), Drug Order (RX), Therapy Order (TX), Diagnostic Procedure Order (DX), a Conditional Drug Order (IFTHRX), a Conditional Therapy Order (IFTHTX), or Free Text (which allows a doctor to handwrite, type or otherwise provide input in free format). This list is displayed as a result of treatment option data stored in the treatment database 30. Optionally, this list may reflect a subset of treatment option data stored in the treatment database 30, the subset being selected by the system after considering, for example, patient medical record data stored in the patient database 24, data stored in the protocol database 32, etc. In the example of FIG. 8, the treatment plan IVPCA has been selected by the clinician, e.g. by the touch of a stylus/pen on a pen-sensitive display screen to select a desired menu item, as is generally known in the art. Accordingly, IVPCA appears in dialog box 164 to indicate the selected treatment plan.

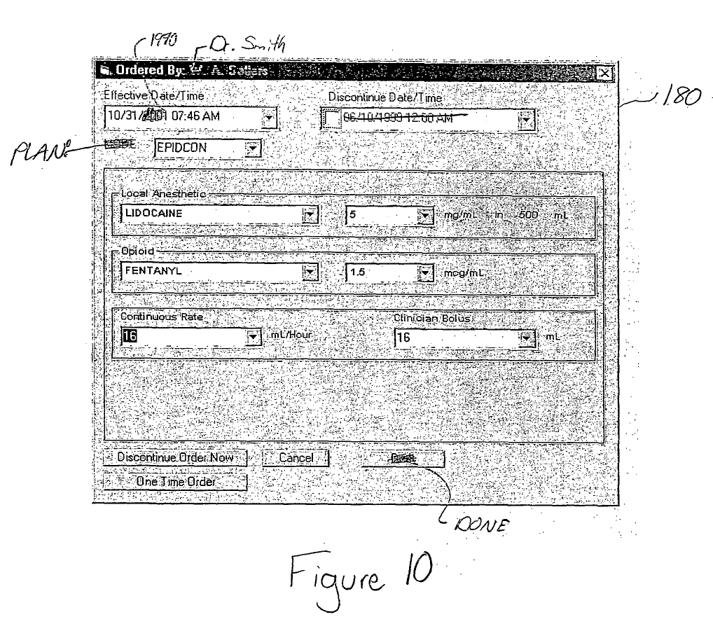

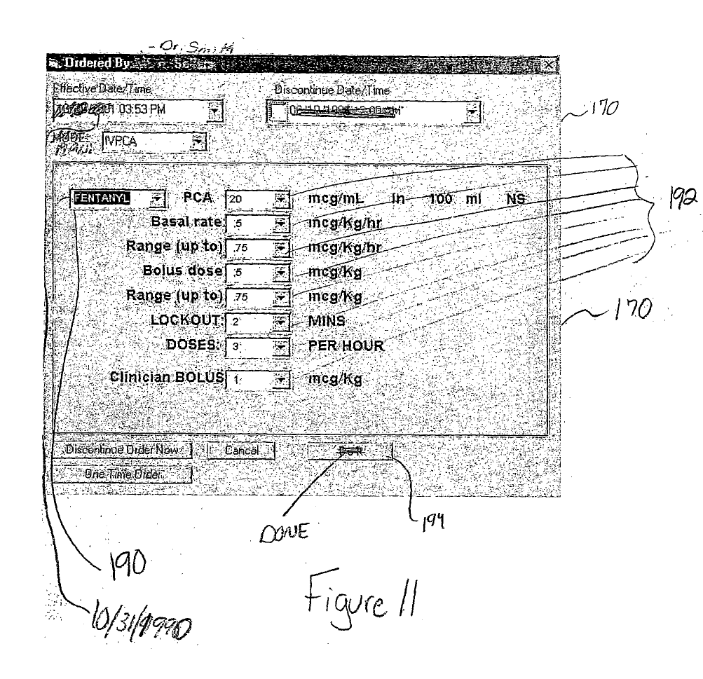

Selection of a treatment plan, e.g. IVPCA, from the drop down menu accessible from window 160 results in display of IVPCA window 170, as shown in FIG. 9. As can be seen from FIG. 9, the clinician-selected plan IVPCA is displayed in dialog box 172. A different plan may be selected by accessing a drop down menu similar to that described above by selecting button 174. The clinician may then select a drug treatment option from a drop down menu 176 accessible by selecting button 178. The drug treatment options displayed in the drop down menu 176 are a result of the treatment option data stored in the treatment database 30 as described above with reference to the treatment plan options. It should be noted that these drug treatment options are stored in the treatment database 30 in relation to UVPCA and so are displayed when IVPCA is selected. For example, if the Epidural Continuous (EPIDCON) treatment option had been selected, the IVPCA window 170 would not appear. Rather an EPIDCON window 180 is displayed with appropriate drug and dosing treatment options as set forth in the treatment database 30 in relation to the EPIDCON treatment option, as shown in FIG. 10. Storing and retrieving data in such related manners and presenting related GUI windows are well known in the art.

In one embodiment, the clinician may simply select a drug from the drop down menu 176, e.g. Fentanyl. Alternatively, the system 20 may recommend a treatment option appropriate for the patient, e.g. Fentanyl, as a function of the patient's medical record data stored in the patient database 24 and/or data relating to treatments available to patients stored in the treatment database 30, etc. In other words, the system considers the treatment options available in the treatment database 30, any known patient data that may affect selection of a treatment option, e.g. data in the patient database 24, and/or protocol data stored in the protocol database 32.

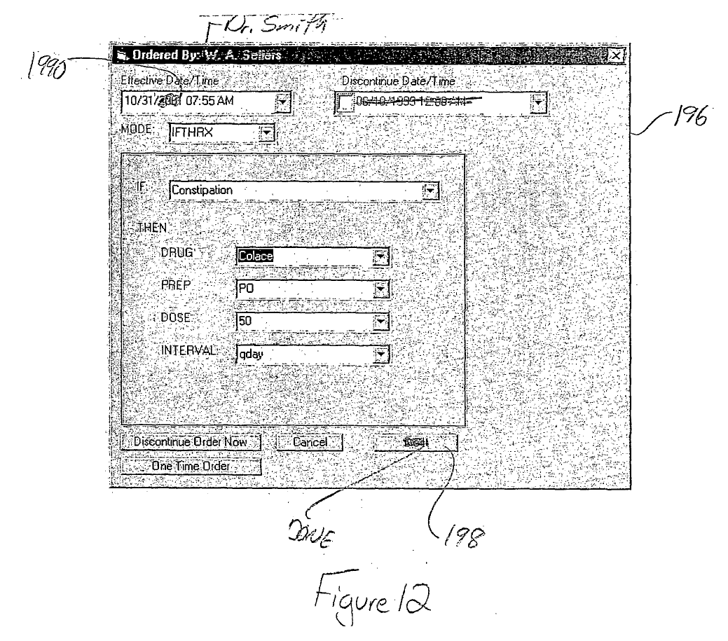

As shown in FIG. 11, once Fentanyl has been selected as the drug treatment option, it is displayed in dialog box 190 in IVPCA window 170. In this example, the treatment database 30 includes a medication database storing dosage data. The treatment module 28 is configured to communicate with the patient database 24 and the medication database of treatment database 30 and to recommend a medication dosage option appropriate for the patient. For example, the treatment module 28 may communicate with the patient database 24 to determine the patient's age and weight. The treatment module 28 then communicates with the medication database/treatment database 30 to determine appropriate dosage and delivery parameters (collectively, dosage) for the patient's age and weight. For example, this occurs responsive to the selection of a drug from the drop down menu 176. The appropriate dosage is then recommended to the clinician by displaying the appropriate dosage in one or more dialog boxes, e.g. 192, in IVPCA window 170.

Accordingly, the clinician need not rely on his/her memory or make reference to an appropriate manual. Additionally, as in the example, when the clinician accepts dosages in weight-dependent (or other factor-dependent) units, the system can perform the necessary calculations. For example, when the clinician accepts the dosage in mcg/Kg/hr, the system can calculate the dosage in mcg/hr for the patient by multiplying by the patient's weight in Kg, e.g. as recorded in the patient database 24. In the example, all of the recommended dosage and delivery parameters may be accepted, rejected or modified by the clinician as the clinician deems to appropriate, e.g. via drop down menus. After the clinician has approved all displayed treatment options, the clinician's selections can be confirmed for recording in the patient database 24 by selecting the “DONE” button 194.

Optionally, the treatment module 28 is configured to display a menu of treatment options as a tree of phrases, as discussed above with reference to FIG. 5.

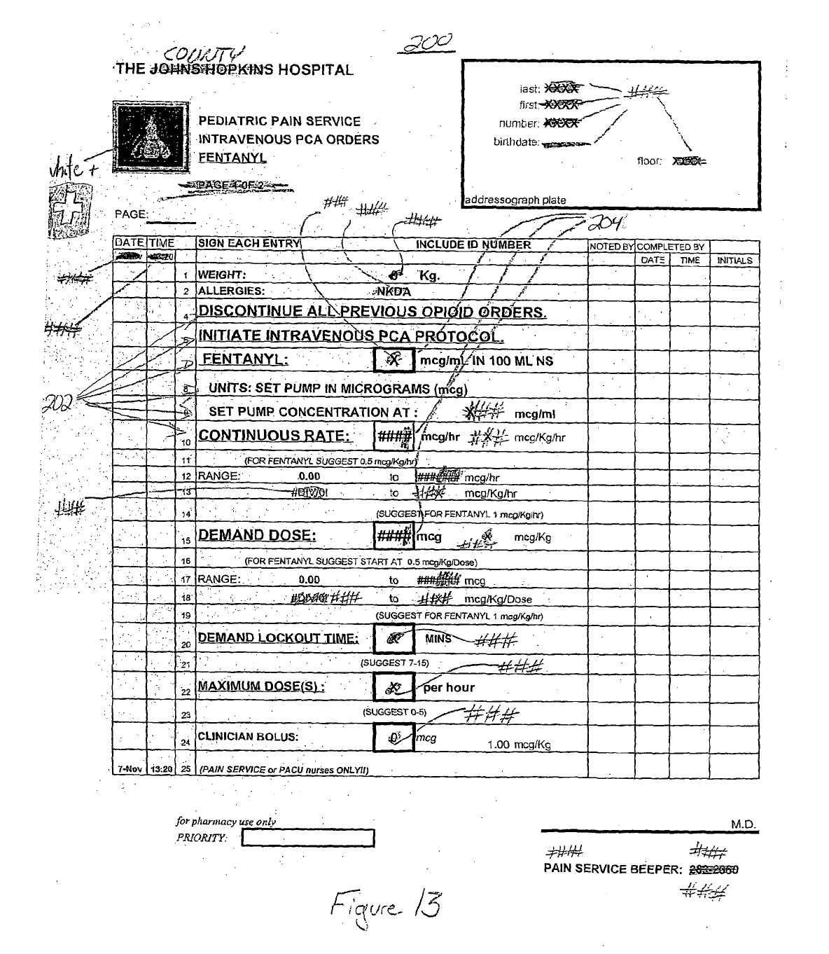

The treatment module 28 may also be configured to guide a clinician to provide conditional orders. For example, IF the patient has a certain condition, THEN give the following prescribed treatment. An exemplary conditional order is shown in a conditional prescription window 196 in FIG. 12, in which Colace is conditionally prescribed if the patient is constipated. The conditional order can be modified by the clinician by using appropriate drop down menus, etc. and can be accepted by the clinician and stored in the patient database 24 by selecting the “DONE” button 198.

The exemplary system also includes a billing database 44 and a billing module 46. The billing module 46 is configured to communicate with the billing database 44 and to display a corresponding menu of clinician-selectable billing level options. The billing database 44 stores billing level data. For example, the billing level data may include billing level options of Inpatient Follow Up—High Level, Inpatient Follow Up Moderate Level, Inpatient Follow Up—Low Level, etc. For example, the billing level options may be displayed in a drop down menu accessible by button 166 of window 160 shown in FIG. 8. In the example of FIG. 8, the clinician has selected “Inpatient Follow Up—Moderate Level”, and the selected billing level option is displayed in dialog box 168. This information may be stored, for example, in the patient database 24 or in the billing database 44 and the documentation module 36 may use this information to generate bills for the patient. Operation of the documentation module 36 is discussed below. Accordingly, the clinician may select an appropriate billing level option at this time, as shown at step 88 in FIG. 3. The billing module 46 queries the system, e.g. text created by the documentation module 36, or clinician selected notes, examination observations, etc., to ensure that the appropriate documentation is provided to support a selected billing level option according to third part regulations, such as regulations of Medicare or third party payers. In other words, the billing module ensures that the clinician has properly document the patient encounter, etc. to ensure that third party regulations are met to allow payment/reimbursement at the maximum extent.

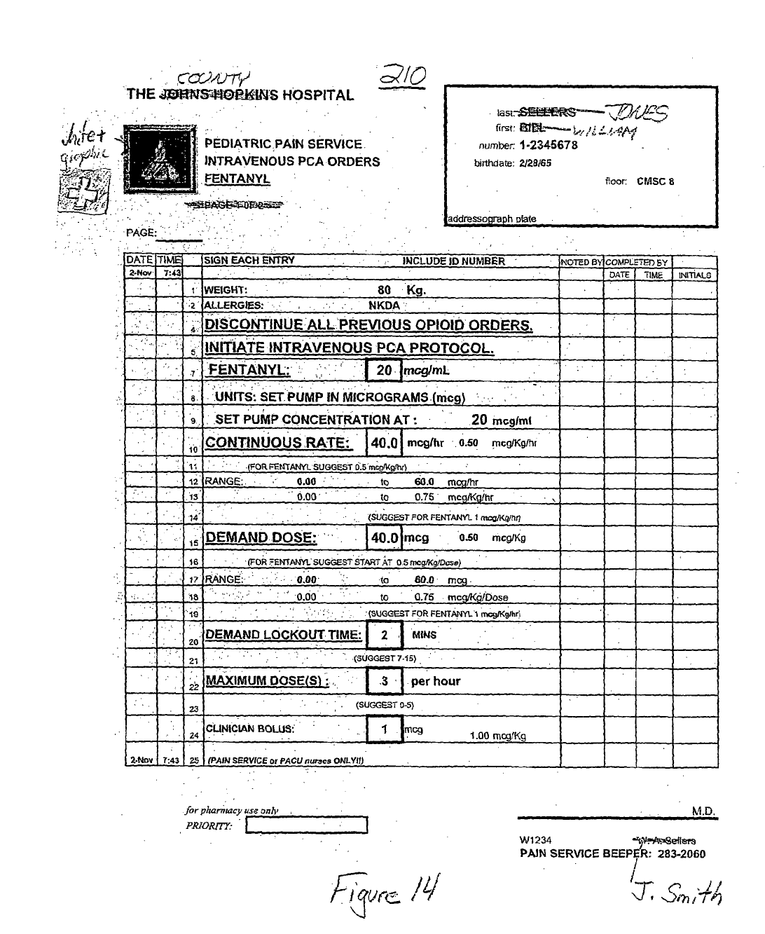

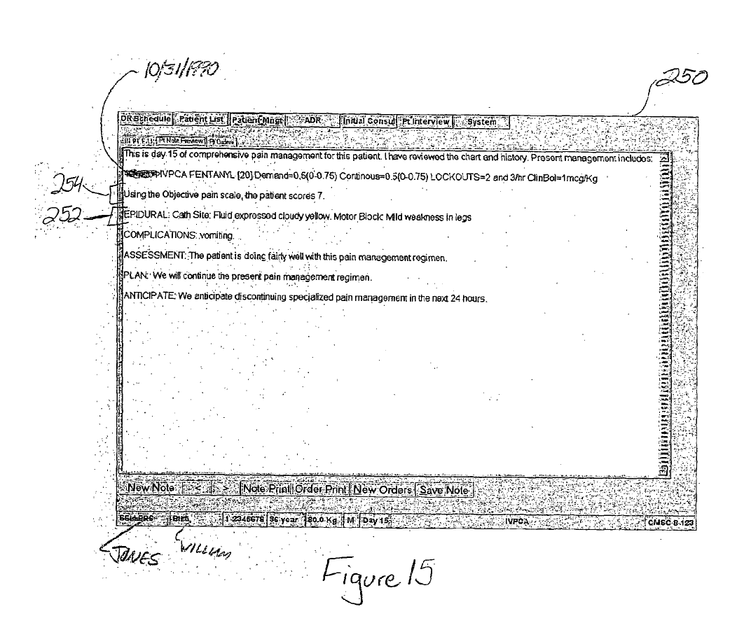

In the exemplary embodiment, the system 20 also includes a template database 34 for storing document templates and a documentation module 36, as shown in FIG. 1. The documentation module is capable of creating a document by incorporating into a document template data from the patient database 24, the treatment database 30 and/or data provided by the clinician, e.g. selected dosage treatment options, etc. The document template may be a document in a format compatible with commercially available software. For example, the document may be in a format readable by a commercially available word processor or spreadsheet software, such as a Microsoft Word or Microsoft Excel. In this manner, the template may be customized for presentation format, etc. by editing the template in such commercially available software. The template provides a form into which data from the system is incorporated to provide a medical record document, such as a prescription, doctor's order, patient notes, a consultation request and report form, or any other form commonly used or desirable in the medical field. An exemplary doctor's order template 200 in Microsoft Word format is shown in FIG. 13. As shown in FIG. 13, the template 200 includes form text, e.g. as shown at 202, as well as data fields shown as ###, e.g. as shown at 204, into which data from the patient database 24, treatment database 30, or clinician provided data, etc. may be entered by the system. FIG. 13 shows the order 210 after incorporating into the data fields of document template 200 of FIG. 12 all relevant data from the patient database 24 (such as name, weight and birthdate) and data provided by the physician and/or stored in the patient database 24 as a results of the clinician's selections made and/or confirmed as shown in FIG. 11. This results in the completed order 210. It should be noted that the system has prepared the order 210 shown in FIG. 14 by making the necessary calculations. For example, the clinician prescribed a continuous (basal) rate of 0.5 mcg/Kg/hr of Fentanyl for the patient. The system referenced the patient database, determined the patient's weight to be 80 Kg, calculated the appropriate dosage to be 40 mcg/hr for the patient, and has incorporated the order of 40 mcg/hr into the order template 300, as shown in FIG. 14. The document may then be printed and taken to a pharmacy or sent electronically to the pharmacy and monitored, mailed, stored in a physical medical record file, used to enter data into a legacy system, etc. Suitable data merging methods and technologies and suitable printing methods and technologies are well known in the art.

It should be noted that the documentation module 36 is capable of creating a textual document as a function of a phrase selected by the clinician from a tree of phrases. For example, by selecting the phrase “yellow” as shown in FIG. 5, the system creates the clinician's note “Fluid expressed is cloudy yellow”. The system may also include a document preview module 38 that allows the clinician to review the document, either before or after printing. In this example, preview module 38 displays preview window 250 shown in FIG. 15 which displays at 252 the clinician's note “Fluid expressed is cloudy yellow” that was created by the documentation module 36. It should be noted also that a drop down menu is a tree of phrases. Accordingly, the clinician's selection of examination option “7” from drop down menu 104 in FIG. 4 results in the documentation module 36 creating the textual note, or document, “Using the Objective pain scale, the patient scores 7.” as shown at 254 in FIG. 15. While the textual document need not be a whole textual sentence, the textual document incorporates more data, information, or characters that the clinician is required to hand write or type.

Accordingly, a medical record document may be created (previewed and/or printed) using the documentation and document preview modules, 36, 38, as shown at steps 90 and 92 in FIG. 3. According to the exemplary method of FIG. 3, data may then be communicated to external systems as necessary, e.g. to store data in a centralized database, etc., as shown at step 94 in FIG. 3. For example, this may achieved by connecting to a network via a wired or wireless connection, as discussed further below with reference to FIG. 2. The exemplary method then ends, as shown at step 95 in FIG. 3.

In the exemplary system of FIGS. 1-15, the system 20 also includes a voice recognition module 40 capable of reacting to a human voice. Voice recognition programming techniques, capabilities and software are well known in the art. For example, the speech recognition module 40 may provide speech-to-text capability, e.g. to record a clinician's dictation as textual notes, text-to-speech capability, e.g. to read a clinician's notes or other system information to the clinician when the clinician cannot view a display of the system, or voice command capability, e.g. to control the system to perform system functions, etc. These capabilities are particularly useful when a clinician's hands are otherwise occupied, as is often the case during patient examination. For example, the voice recognition module 40 may be used to interact with the system in the method of FIG. 3. Speech recognition software is well known in the art.

In the exemplary system of FIGS. 1-15, the system 20 also includes a research module 42 capable of analyzing multiple patients patient data and/or treatment data as a function of a selected condition and/or treatment. For example, because multiple patient's data is accessible by the system, the system can sort and/or group medical records by selected patient data, such as patient conditions, complaints, characteristics, treatments, etc. stored in the patient database 24. Accordingly, the system 20 can lessen the research burden on a clinician by performing at least preliminary analysis of patient data, e.g. to analyze responsiveness to a given treatment for multiple patients. The research module 42 optionally includes an internal randomization protocol to facilitate randomized control trials.

FIG. 2 is a block diagram of a clinician's assistant system 210 in accordance with the present invention. The system 50 includes a general purpose microprocessor 52 and a bus 54 connecting and enabling communication between the microprocessor 52 and the components of the system 50 in accordance with known techniques. The system 50 typically includes a user interface adapter 56, which connects the microprocessor 52 via the bus 54 to one or more interface devices, such as a keyboard 58, mouse 60, pen-sensitive touch screen 62 and/or other interface device 64, which can be any user interface device, such as a digitized entry pad, etc. The bus 54 also connects a display device 66, such as an LCD screen or monitor, to the microprocessor 52 via a display adapter 68. The bus 54 also connects the microprocessor 52 to memory 70 and long-term storage 72 (collectively, “memory”) which can include a hard drive, diskette drive, tape drive, etc. For example, a system according to the present invention may be implemented in a pen-based computer, or a system including pen-based computers.

The system 50 may communicate with other computers or networks of computers, for example via a communications channel, network card or modem 74. The system 50 may be associated with such other computers in a LAN or a wide area network (WAN), or the system 50 can be a server in a client/server arrangement with another computer, etc. All of these configurations, as well as the appropriate communications hardware and software, are known in the art.

Software programming code embodying the present invention is typically stored in memory of some type, such as the memory 70 and/or storage 72. For example, software programming code embodying all modules shown in FIG. 1 may be stored in the memory 70 and/or storage 72 of a single pen-based computer. Alternatively, for example, the examination and treatment module and/or other modules may be stored in the memory 70 and/or storage 72 of a single pen-based computer while all databases are stored remotely, e.g. on a server in a networked environment. These examples are illustrative only and many other alternative embodiments are suitable, as will be appreciated by those skilled in the art.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A clinician's assistant system for communicating with a patient database storing medical record data relating to a patient and with a treatment database storing data relating to treatments available to patients, the clinician's assistant system comprising:
an examination module capable of guiding a clinician in examining the patient and recording examination data for storage in the patient database; and
a treatment module capable of guiding the clinician in treating the patient and recording treatment data for storage in the patient database.

2. The clinician's assistant system of claim 1, wherein said examination module and said treatment module are configured to guide the clinician via a GUI display.

3. The clinician's assistant system of claim 1, further comprising:
a protocol database storing data relating to an assessment protocol;
wherein said examination module is configured to automate said assessment protocol.

4. The clinician's assistant system of claim 1, further comprising:
a protocol database storing data relating to a treatment protocol;
wherein said treatment module is configured to automate said treatment protocol.

5. The clinician's assistant system of claim 1, further comprising:
an examination database storing data relating to examination observation options;
wherein said examination module is configured to communicate with said examination database and to display a corresponding menu of clinician-selectable examination options.

6. The clinician's assistant system of claim 5, wherein said examination module is configured to display said menu as a tree of phrases.

7. The clinician's assistant system of claim 6, further comprising:
a documentation module capable of creating a textual document as a function of a phrase selected by the clinician from said tree of phrases.

8. The clinician's assistant system of claim 7, further comprising:
a document preview module capable of displaying the textual document for review by the clinician.

9. The clinician's assistant system of claim 7, further comprising:
a template database capable of storing a document template;
wherein said documentation module is capable of creating said textual document by incorporating into the document template data from the patient database and/or the treatment database and/or data associated with a phrase selected by the clinician from said tree of phrases.

10. The clinician's assistant system of claim 1, wherein said treatment module is configured to communicate with the treatment database and to display a corresponding menu of clinician-selectable treatment options.

11. The clinician's assistant system of claim 9, wherein said treatment module is configured to display said menu as a tree of phrases.

12. The clinician s assistant system of claim 10, further comprising:
a documentation module capable of creating a textual document as a function of a phrase selected by the clinician from said tree of phrases.

13. The clinician's assistant system of claim 12, further comprising:
a template database capable of storing a document template;
wherein said documentation module is capable of creating said textual document by incorporating into the document template data from the patient database and/or the treatment database and/or data associated with a phrase selected by the clinician from said tree of phrases.

14. The clinician's assistant system of claim 1, wherein the treatment module is configured to communicate with the patient database and the treatment database and to recommend a treatment option appropriate for the patient as a function of the patient's medical record data stored in the patient database and data relating to treatments available to patients stored in the treatment database.

15. The clinician's assistant system of claim 1, wherein the treatment database comprises a medication database storing dosage data, and wherein said treatment module is configured to communicate with the patient database and the medication database and to recommend a medication dosage option appropriate for the patient as a function of the patient's medical record data stored in the patient database and dosage data stored in the medication database.

16. The clinician's assistant system of claim 1, further comprising:
a template database capable of storing a document template; and
a documentation module for creating a document by incorporating into the document template data from said patient database and/or the treatment database and/or data provided by the clinician.

17. The clinician's assistant system of claim 15, wherein said template database stores a document template in a format compatible with commercially-available software.

18. The clinician's assistant system of claim 1, further comprising:
a voice recognition module capable of reacting to a human voice.

19. The clinician's assistant system of claim 18, wherein said voice recognition module provides speech-to-text capability.

20. The clinician's assistant system of claim 18, wherein said voice recognition module provides text-to-speech capability.

21. The clinician's assistant system of claim 18, wherein said voice recognition module provides voice command capability.

22. The clinician's assistant system of claim 1, further comprising:
a research module capable of analyzing data relating to multiple patients.

23. The clinician's assistant system of claim 1, farther comprising:
a billing database capable of storing billing level data;
a billing module configured to communicate with said billing database and to display a corresponding menu of clinician-selectable billing level options.

24. A clinician's assistant system for communicating with a patient database storing medical record data relating to a patient and a treatment database storing data relating to treatments available to patients, the clinician's assistant system comprising:
an examination module capable of guiding the clinician in examining a patient and recording examination data for storage in the patient database;
a treatment module capable of guiding the clinician in prescribing a treatment for the patient and recording treatment data for storage in the patient database; and
a voice recognition module capable of reacting to a human voice;
wherein said examination, treatment and voice recognition modules are implemented on a portable, pen-based computer.

25. The clinician's assistant system of claim 24, further comprising:
a template database capable of storing a document template; and
a documentation module capable of creating a document by incorporating into a document template data from said patient database and/or said treatment database and/or data provided by the clinician.

26. The clinician's assistant system of claim 25, wherein said template database stores a document template in a format compatible with commercially-available software.

27. A clinician's assistant system for communicating with a patient database storing medical record data relating to a patient, the clinician's assistant system comprising:
an examination database storing data relating to examination observation options;
a treatment database storing data relating to treatments available to patients;
an examination module capable of guiding the clinician in examining a patient and recording examination data for storage in the patient database, said examination module being configured to communicate with said examination database and to display a corresponding menu of clinician-selectable examination options as a first tree of phrases; and
a treatment module capable of guiding the clinician in prescribing a treatment for the patient and recording treatment data for storage in the patient database, said treatment module being configured to communicate with said treatment database and to display a corresponding menu of clinician-selectable treatment options as a second tree of phrases.

28. The clinician's assistant system of claim 28, further comprising:
a voice recognition module capable of reacting to a human voice.

29. The clinician's assistant system of claim 27, further comprising:
a template database capable of storing a document template; and
a document creation module capable of creating a document by incorporating into a document template of said template database, data from said patient database and/or said treatment database and/or data provided by the clinician.

30. The clinician's assistant system of claim 27, wherein said template database stores a document template in a format compatible with commercially-available software.

31. A clinician's assistant system for communicating with a patient database storing medical record data relating to a patient, the clinician's assistant system comprising:
a computer comprising a microprocessor, a memory operatively connected to said microprocessor, and first instructions stored in said memory and executable by said microprocessor to guide a clinician in examining the patient, and second instructions stored in said memory and executable by said microprocessor to guide the clinician in treating the patient.

32. The system of claim 31, further comprising:
a server computer storing said patient database and/or said treatment database;
wherein said computer further comprises a telecommunications device operatively connected to said microprocessor and capable of communicating with said server computer via a communications network.
